(19) United States
(12) Patent Application Publication
(10) Pub. No.: US 2005/0228824 A1
(43) Pub. Date: Oct. 13, 2005

(54) Intelligent consequence management system

(76) Inventors: Joseph A. Gattuso, Muskegon, MI (US); Timothy Clayton, Chula Vista, CA (US)

Correspondence Address: BRYAN CAVE LLP, 211 NORTH BROADWAY, SUITE 3600, ST. LOUIS, MO, 63102-2750, US

(21) Appl. No.: 10/815,569

(22) Filed: Apr. 1, 2004

(51) Int. Cl. G06F 17/30

(52) U.S. Cl. 707/104.1

(57) ABSTRACT

A method to selectively disseminate information in a distributed computer system of the type having a plurality of originating and target nodes. A publisher is associated with an originating node and is authorized to provide an informational message defined by a set of attributes to the system. A subscriber is associated with a target node and is authorized to receive information from the system. Each subscriber may establish a set of content filters to identify the attributes of informational messages of interest to such subscriber. The informational messages may then be screened to determine the subscribers that should receive the informational message based on the subscriber's content filters. In order to transfer the published informational message from the originating node associated with the publisher to the target nodes associated with all subscribers determined to receive the message, a description of the first informational message is transmitted to the target nodes associated with such subscribers. The description is reviewed to determine if the target node already contains the informational message and such determination is provided back to the originating node. In this fashion, the informational message is only transferred to the target nodes associated with those subscribers requiring the informational message.

This invention was made with Government support and the Government has certain rights in the invention pursuant to Small Business Innovation Research Contract Nos. N00178-03-C-3047 and N00178-04-C-3054.

### FIELD OF THE INVENTION

This invention generally relates to methods and systems for the creation, dissemination and management of information and, more particularly, to methods and systems used to organize, store, and replicate information efficiently.

### BACKGROUND OF THE INVENTION

Consequence management may be defined as an emergency management function to protect public health and safety, restore essential government services, and provide emergency relief to governments, businesses, and individuals affected by some condition or act. Effective consequence management requires secure communication and collaboration between geographically and doctrinally disparate agencies and their personnel. Thus, consequence management requires people and systems to be properly notified of events and provided appropriate information that is of direct importance to them in a timely manner. Users must also have the ability to provide information that may be of special relevance to others and have it distributed to authorized recipients quickly and automatically. In other words, it is important that the right information be provided to the right people in the minimum possible time.

A distributed computer system that enables various entities to communicate and collaborate effectively preferably decentralizes information engineering, knowledge engineering and system engineering duties, minimizes economic cost to potential system participants, and ensures a widespread implementation of the system to as many participants as possible.

Conventional distributed computer systems rely on a central organization to evaluate and determine the informational needs of its various users and to coordinate the movement of information through the system. In many instances, users of such conventional systems receive information that is not relevant to their particular function or receive critical information in an untimely fashion. However, no single organization, development team, or individual can possibly ascertain the information requirements of all potential system users. Simply identifying all of the potential system users is a nearly impossible task. In addition, the breadth and depth of the information to be managed by the system cannot possibly be known in its entirety at design time. Furthermore, the needs of any one user will change over time. Thus, the information management problem in such a large user domain is ever-changing.

Thus, there is a strong need for a system that allows organizations, groups, or individuals to selectively receive, request, and control critical consequence management information. Unlike extant communication systems, the present invention preferably must allow participants to define the types of information they are interested in receiving, the circumstances under which such information should be received, and the information processing tasks that should be implemented upon receipt. A preferred system would enable users of the system to determine exactly what information is stored and managed by the system, and specify exactly what information is delivered and received, and under what circumstances or conditions. The system would enable users to design their own information and would adapt to the needs of new users who were not anticipated to be participants at the time of development. The system of the present invention provides these and other advantages.

### SUMMARY OF THE INVENTION

The invention provides a method to selectively disseminate information in a distributed computer system of the type having a plurality of originating and target nodes. The method comprises a series of steps, which need not be performed in the order recited herein. A set of publishers and a set of subscribers must be defined. A publisher is associated with an originating node and is authorized to provide information to the system. Conversely, a subscriber is associated with a target node and is authorized to receive information from the system. A single node may be defined as both an originating node and a target node and, thus, a single node may have both publishers and subscribers associated with such node. In addition, a publisher may also be a subscriber and any subscriber may also be defined as a publisher at various times.

In one embodiment of the system, one of the publishers publishes a first informational message, which is defined by a set of attributes related to the content of the informational message. The attributes of an informational message may be used to determine which subscribers are interested in, and have authority to receive, the message. For example, each subscriber may establish a set of content filters to identify the attributes of informational messages of interest to such subscriber. The informational messages may then be screened to determine the subscribers that should receive the informational message based on the subscriber's content filters. In order to transfer the published informational message from the originating node associated with the publisher to the target nodes associated with all subscribers determined to receive the message, a description of the first informational message is transmitted to the target nodes associated with such subscribers. The description is reviewed to determine if the target node already contains the informational message and such determination is provided back to the originating node. In this fashion, the informational message is only transferred to the target nodes associated with those subscribers requiring the informational message.

The present invention may also allow a subscriber receiving an informational message to automatically publish another informational message. Thus, each subscriber may establish automatic content-based communication triggers. The published informational messages are then screened to determine if the content of the message or its attributes meet an established communication trigger. If so, a second informational message may be published by the receiving subscriber.

### BRIEF DESCRIPTION OF THE DRAWINGS

These and other features, aspects and advantages of the invention will become more fully apparent from the following detailed description, appended claims, and accompanying drawings where:

FIG. 1 illustrates a publisher in accordance with the present invention and its attributes;

FIG. 2 illustrates a subscriber in accordance with the present invention and its attributes;

FIG. 3 illustrates the content and attributes of informational messages;

FIG. 4 is a block diagram illustrating the steps of the presently preferred method of the present invention;

FIG. 5 illustrates a representative event and event type;

FIG. 6 illustrates the content and attributes of a topic;

FIG. 7 is a simplified block diagram illustrating the consequence management network of the present invention;

FIG. 8 is a simplified block diagram illustrating the consequence management cluster and certain of its interfaces;

FIG. 9 is a simplified block diagram illustrating the primary components and interfaces of an intelligent server node; and

FIG. 10 illustrates the contents and structure for a database used in the present invention.

These drawings are provided for illustrative purposes only and should not be used to unduly limit the scope of the present invention.

### DESCRIPTION

The system is organized as a distributed computer system identified as an intelligent consequence management network or system having a plurality of originating and target nodes, which are organized into consequence management clusters. The preferred network architecture is a mixture of client-server and peer-to-peer topologies, which allows systems of varying capabilities to participate on the network, in the most suitable way. Computers with lesser capabilities may take on a client role and access a nearby server via the ubiquitous web browser, while more capable computers may utilize a desktop version of the application and take on a peer-to-peer role to assist with communication of information. The most capable systems would play a server role and act as super-nodes on the network, managing large databases of information and providing it to clients and other servers alike.

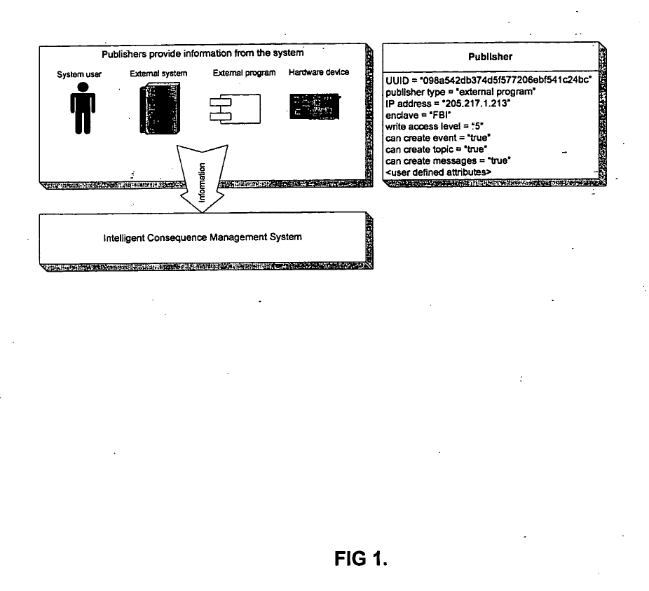

The system includes a set of publishers authorized to provide information to the system. Each publisher is preferably associated with an originating node of the system. As shown in FIG. 1, publishers may be individual users, external systems, external programs, hardware devices, and the like. Publishers have associated certificates and system credentials or attributes that define the types of informational messages each publisher is allowed to publish to the system and under what circumstances. Prior to publication, the system may evaluate the informational message to ensure that the publisher has the appropriate system credentials to publish the informational message. Examples of system credentials organized as an attribute list for a publisher is shown in FIG. 1.

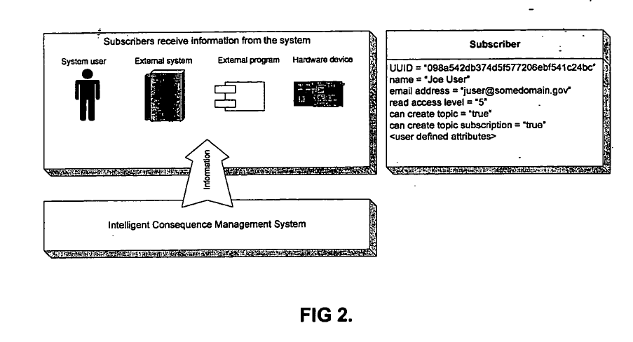

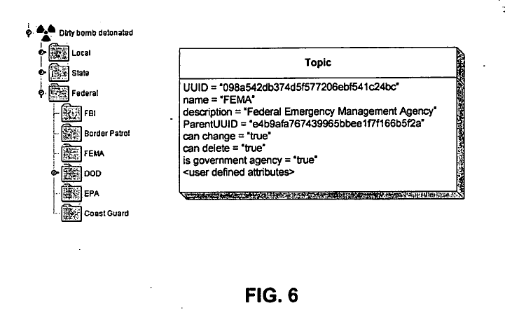

As shown in FIG. 2, the system also includes a set of subscribers, such as users, systems, devices, programs, or the like, authorized to receive information from the system. Preferably, each subscriber is associated with a target node of the system. As with publishers, subscribers have associated PKI certificates and system attributes and credentials that define access levels, specify exactly what types of information the subscriber is allowed to receive from the system, and under what circumstances. An example attribute list for a subscriber is shown in FIG. 6.

The system may also contain means for enrolling publishers as a verified providers of information to the system and subscribers as verified recipients of information from the system. For example, new publishers and subscribers may be assigned appropriate guest-level access rights when first accessing the system. As a guest, such a new user may not have rights to provide new information to the system, and can only obtain information deemed appropriate for public guest access. Later, the new user may optionally complete an enrollment procedure. After the new user's credentials have been verified and appropriate communication certificates issued, the new user and their associated system can automatically take on a greater, more secure role in the system.

Both publishers and subscribers are identified with a universally unique identifier (UUID). UUIDs are values such as a string of numbers and letters that are unique in time and space. Preferably, the algorithm used to generate a UUID guarantees that once a particular UUID is generated, it will never be generated again for another entity. As an example, UUID may be generated by creating an MD5 (Message Digest Algorithm version 5) message digest on a universally unique string of information. MD5 is the RFC standard algorithm used to generate digital signatures. An MD5 message digest is guaranteed unique when calculated on a unique string of information. The message digest may be a 16-byte long number, when represented in hex results in a 32 character long string composed of hex digits.

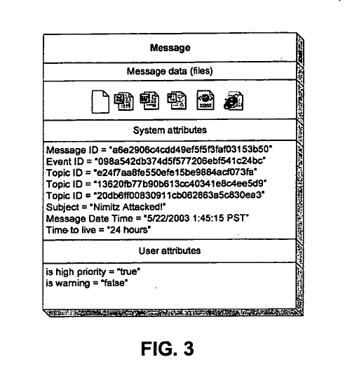

Communication is accomplished from publishers to subscribers using informational messages that may be defined by a set of attributes related to the content of the informational message. Informational messages are functionally equivalent to conventional e-mail messages. Informational messages may contain any type or amount of information that can be represented as computer files. Informational messages are preferably associated with a specific event and may be associated with one or more topics as explained below. Preferably, informational messages are structured according to the Multipurpose Internet Mail Extensions (MIME) standard in use on the internet and, therefore, are compatible with existing e-mail servers, web servers, and will easily propagate through firewalls and proxies. FIG. 3 illustrates a representative informational message, including various forms of attached data files, and a listing of system and user attributes. Informational messages may have any arbitrary attributes associated with them. Attributes of an informational message might include priority or warning flags, expiration dates, and the like, all of which are defined by publishers.

A publisher of an informational message may not know which subscribers are interested in the content of the message. Further, in some scenarios, some informational messages may only be pertinent to a subscriber at specific times or under certain circumstances. The present invention, therefore, includes the concept of content based filtering to allow subscribers to specify what types of information they want delivered to them, and under what circumstances they want it delivered, based on the actual content of the informational message. For example, if users at the FBI want to make their terrorist most-wanted list along with digital pictures available to others, they may choose to publish the information. Users that have specified filters for “terrorist attach” related information would receive this information automatically on their system. In another example, users at the California State Police may specify a filter that they are only interested in terrorists from the most-wanted list that were last seen in the state of California. In yet another example, if the users at the EPA want to know what water supplies have been compromised and where, they may subscribe to all information containing water-quality reports marked with attributes identifying contaminated water supplies.

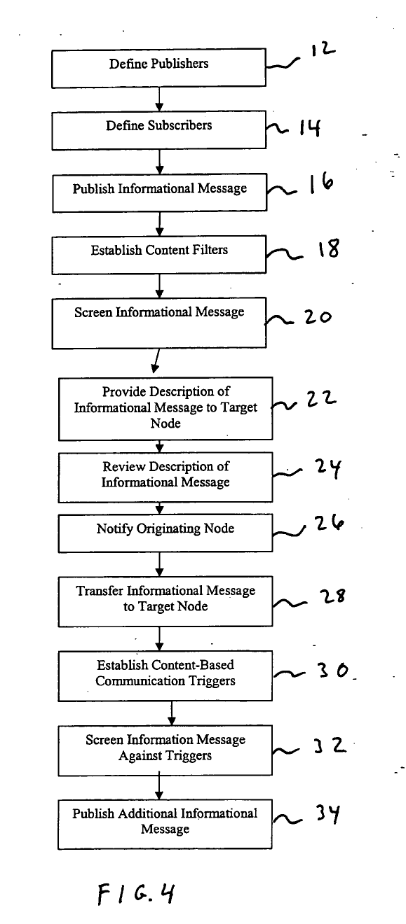

Having described the concepts of publishers, subscribers, informational messages and filters, FIG. 4 illustrates the principle steps of the method of one embodiment of the present invention. As described above, a set of publishers and a set of subscribers must be defined, as shown in steps 12 and 14. In step 16, one of the publishers publishes a first informational message, which is defined by a set of attributes related to the content of the informational message.

The attributes of an informational message may be used to determine which subscribers are interested in, and have authority to receive, the message. For example, in step 18, each subscriber may establish a set of content filters to identify the attributes of informational messages of interest to such subscriber. The informational messages may then be screened in step 20 to determine the subscribers that should receive the informational message based on the subscriber's content filters.

Preferably, this screening function is performed by the originating node associated with the publisher of the published informational message. The originating nodes use the content-based filters to examine the system and user-defined attributes of the informational messages in the system to determine the appropriate recipients of the information. Once the correct recipients or subscribers are known, the originating node can intelligently send the information through the peer-to-peer network so that it arrives only at the target nodes servicing the intended subscribers. The peer-to-peer topology allows for the possibility that information can arrive at any given destination via many pathways. It is entirely possible, therefore, that one target node can receive the same information from multiple originating nodes on the network. This provides built-in network fault tolerance, and is a fundamental benefit of peer-to-peer topology. However, to prevent unnecessary duplicate transmissions, each node maintains an “available objects list” in its local database. If an originating node needs to send a batch of information to a target node, it can first send a description of the informational message, as shown in step 22, such as a small list of UUIDs, identified as the transmit object list, identifying the objects it wishes to send. In step 24, the target node receives the transmit object list and compares it against its own available objects list. Then, in step 26, the target node responds with a subset of the transmit object list, identified as the requested object list, that identifies the actual information it needs, to the originating node. The originating node then only transfers the objects identified in the requested object list, as shown in step 28, thus eliminating the duplicate communication of information already resident on the target node.

Prior to transferring an informational message to a target node associated with a subscriber, the system may examine the credentials of the subscriber to ensure that it is entitled to receive the informational message.

The preferred method of the present invention also allows for the optional automatic publication of information by a subscriber receiving an informational message. For example, each subscriber is permitted to establish automatic content-based communication triggers (step 30). Communication triggers are automated software processes that retrieve or deliver information automatically based on the content of information that is processed or received by the system. A communication trigger uses information from content-based filters to automatically trigger communication between nodes. For example, with an appropriate trigger installed on the system, users can configure their system to automatically retrieve the forecasted winds from a known weather system upon receipt of notification of a chemical agent being dispersed in a given area. Upon receipt of the weather information, another communication trigger on the system can send out notifications, with the weather information appended, to all systems within the impacted geographic area. The informational message received by a subscriber is screened in step 32, to determine if the content of the message or its attributes meet one of the pre-established communication triggers. If the trigger is met, a second informational message may be published by the subscriber in step 34, following the steps outlined above. In other words, at this point, the subscriber becomes a publisher. In another embodiment, the subscriber receiving the first informational message may need to retrieve information from another source, such as an internal or external database, and then publish such retrieved information to the network. The need to retrieve the additional information may be determined by the content or attributes of the first received informational message meeting a pre-established communication trigger. For example, users in the Environmental Protection Agency may need their consequence management system to retrieve tide and current information from a known oceanographic database when an oil spill is reported to the consequence management network. A user at the EPA may then author a custom communication trigger that automatically performs an information retrieval from the database when the oil spill message is received by the EPA system. In addition, the EPA system may then automatically broadcast the retrieved information for receipt and use by others on the network.

In yet another embodiment, a publisher may only publish a small portion of the information it has on a given subject matter. The balance of the information related to the subject may be stored within a data repository. The informational message published by the publishers provides an indication that the data repository exists and provides a form of index or another similar description of the information stored within the repository. A subscriber receiving the informational message may then gain access to the data repository associated with the received informational message.

In another embodiment, a data repository may be associated with a published informational message, wherein the data repository contains additional information related to the content of the informational message. Attributes identifying the information contained in the data repository may be published. These published attributes may then be screened to determine the subscribers that should receive the additional information contained in the data repository based on the subscriber's content filters. The additional information may then be provided to all target nodes associated with those subscribers requiring or desiring the additional information.

The system may alternatively automatically provide for publication of the additional information stored in the data repository to the appropriate subscribers. For example, the publisher may publish attributes identifying the information contained in the data repository. The published attributes may be screened to determine the subscribers that should receive the additional information contained in the data repository based on the subscriber's content filters. The additional information may then be provided to the target nodes associated with those subscribers requiring the additional information.

A user-configurable data repository allows a user, such as a publisher or a subscriber, to define new types of information, the attributes that define and characterize the information, and specify how it is organized and related to other information in the system. Users can create boxes and folders to contain their files, and can electronically staple information together. Each file, cabinet, folder, or box can be given arbitrary attributes and tags. For example, users at the Environmental Protection Agency can create a box labeled “Water Test Results” and associate tags such as “contains harmful chemical agents” or “allow public access” with selected files within the box.

Once files are placed in the user's data repository, the files can be associated with any event, topic or informational message in the system. As users in other consequence management clusters receive messages from the system, such users can navigate to and retrieve any user's file that is associated with the message, topic or event.

The events, topics, informational messages, and attributes associated with the files in the user's repository function as criteria for content-based filters and communication triggers. As an example, subscribers may define filters such as “send me all files published by an user in the EPA that have been made public that have been market with a tag “contains harmful chemical agents.”

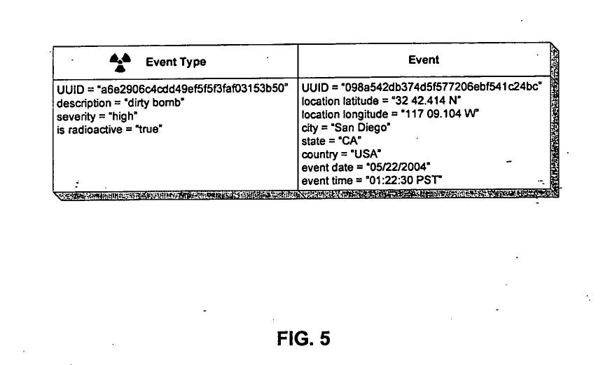

The system may also allow a publisher to define a series of event types and upon the occurrence of a specific event of a defined event type, the publisher will automatically publish an informational message containing information relating to the occurrence of the specific event. An event type may be defined as categorical information and meta-data about various types of consequence management events involving such things as chemical weapons, biological weapons, dirty bombs, terrorist attacks, and the like. Events are the initial activities that occur at a place and time and that trigger the consequence management functions of communication and collaboration. Basic attributes of events include a UUID, descriptions, geographic, location information, time and user supplied information. For example, FIG. 5 illustrates the data structure for an event such as a dirty bomb detonation in San Diego, Calif. The information contained in the data structure constitutes an event and is the catalyst by which all consequence management communication and collaboration will follow.

Topics are an organizational construct for messages and act as containers for them. Topics, similar to event types, contain categorical information about a particular subject to interest. Topics, and their associated attributes, are arbitrary and defined by publishers and subscribers. In addition, topics can be organized into a tree structure resembling a file system. Each topic in the tree structure can have arbitrary attributes associated with them. For example, topics can have permission attributes and tags. An example of a topic is illustrated in FIG. 6.

Transfer of informational messages throughout the system may include the use of a public encryption key technology. For example, each subscriber may have an associated public encryption key and each transferred informational message to such subscriber is encrypted using the subscriber's public encryption key. The use of public encryption key technology, such as Public Key Infrastructure (PKI), and other technologies such as Secure Sockets Layer (SSL) to transmit and encrypt/decrypt and authenticate information sent between nodes of the system assists in achieving the goal that the right information is delivered to the right people. Preferably, the system requires an administrative certificate authority for the entire network to be established to support creation of new PKI certificates and verification of identity of systems and individuals on the network. Preferably, in order to simplify system administration and maintenance, the distribution and utilization of PKI certificates throughout the system is completely automated.

When an originating node has a sensitive message to send to another node, it must first determine who the potential recipients of the information are, taking into account not only all users' defined communication filters and triggers, but the security descriptors on the information itself and the available certificates on the network as a whole. Once the list of recipients is established, the originating node sends the message to each target node associated with an authorized recipient subscriber, properly encrypting the message using the intended subscriber's public key. For example, if a publisher associated with an originating node desires to transmit a secure message about an anthrax discovery, and the data is marked top secret, the system would locate all subscribers on the system who have specified an anthrax discovery communication filter and also have the necessary security clearance based on their certificate credentials. Once the list of subscribers is determined, the system would individually encrypt and send each message using each subscriber's public key.

The method described herein may be implemented as a set of computer programs that is distributed to various users. The computer program(s) preferably includes instructions for defining a set of publishers authorized to provide information to the system and associating each publisher with an originating node of the system; instructions for defining a set of subscribers authorized to receive information from the system and associating each subscriber with a target node of the system; instructions for publishing a first informational message, wherein the first informational message is defined by a set of attributes related to the content of the informational message; instructions for allowing each subscriber to establish a set of content filters to identify the attributes of informational messages of interest to each subscriber; instructions for screening the first published informational message to determine the subscribers that should receive the informational message based on the subscriber's content filters; instructions for providing a description of the first informational message to the target nodes associated with the subscribers determined to receive the information; instructions for reviewing the description to determine if the target node already contains the first informational message; instructions for notifying the originating node as to whether the target node already contains the first informational message; and instructions for transferring the first published informational message from the originating node associated with the publisher to the target nodes associated with those subscribers requiring the first informational message. Further instructions may be included to implement the various additional and alternative embodiments described herein.

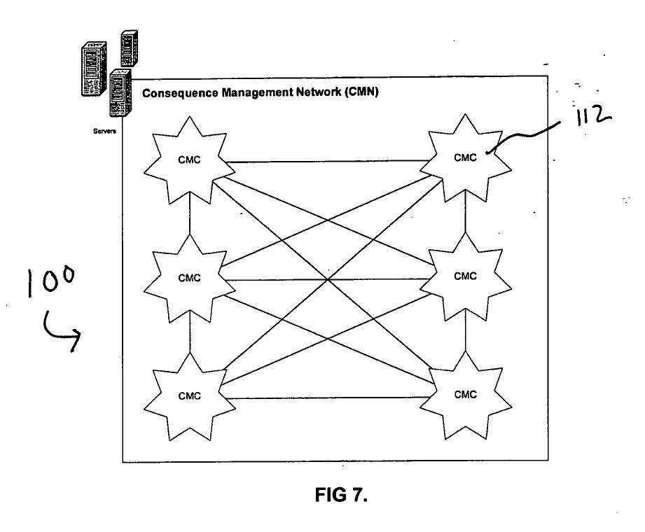

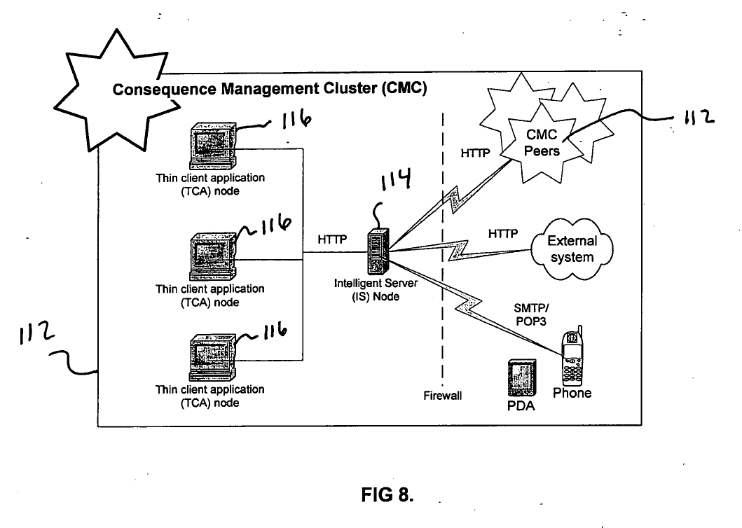

The presently preferred method operates in conjunction with a distributed computer network identified as a consequence management network or system. As illustrated in FIG. 7, the network 100 is comprised of a set of consequence management clusters 112, joined together in a peer-to-peer fashion. As shown in FIG. 8, each consequence management cluster 112 includes an intelligent server node 114, and a plurality of thin client application nodes 116. Thus, each consequence management cluster 112 functions as a client-server based network of computers similar to the structure of a local area network or sub-network.

The peer-to-peer networking model for the consequence management clusters allows for dynamic reconfiguration of communication paths, and potentially allows each and every system in the network to communicate with any other system. The communication means is similar to the Gnutella™ peer-to-peer file sharing protocol used to exchange files on the internet. In this protocol, any node can act as either a file sharing client or a file sharing server to any other node. The result is that communication pathways are dynamically configured and re-configured on the fly, allowing unrestricted flow of information to millions of computers simultaneously. One primary difference between conventional file sharing protocols and the architecture described herein is the direction of information flow. Conventional file sharing network protocols pull information on demand as the user requests the particular information of interest. In the present architecture, information is pushed automatically between systems, based on pre-defined user queries, such that the users receive their information automatically and without intervention.

The intelligent server nodes 114 communicate with other information server nodes located in other consequence management clusters 112. The intelligent server nodes 114 intelligently and selectively replicate information of interest to their peer consequence management clusters, forming a synchronized network of distributed information. As shown in FIG. 8, the information server nodes 114 may also have the capability of interfacing with external system or super thin client devices such as PDAs or cell phones via appropriate interfaces such as HTTP and SMTP/POP3. Any intelligent server node 114 may server at various times as an originating node or a target node.

Preferably, computers communicating through the system use the most commonly available protocols such as HTTP, SMTP, and POP3. Use of these conventional protocols allows communication with any system, computer, or device that supports email. As an example, consequence management alerts may be sent to cell phones and PDAs via these protocols.

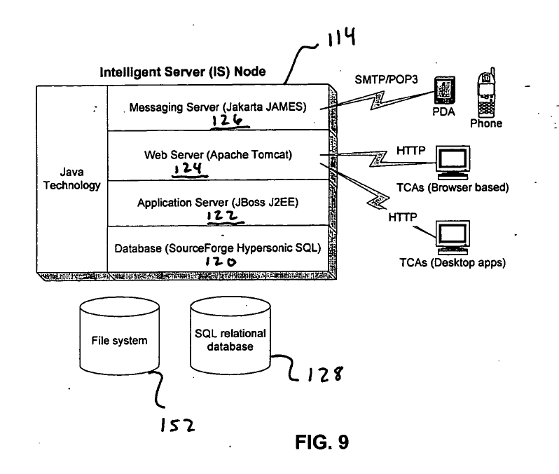

FIG. 9 illustrates the preferred components of each intelligent server node 114, which includes a database server component 120, which manages all information for the consequence management cluster, the user configurable data repository, configuration of content-based filters and communication triggers, network and system configuration data, and all data received, sent or processed by the system. Preferably, the database server component 120 is a relational database engine, such as a Hypersonic SQL database server available from SourceForge. The user configurable data repository may be files stored with meta-attributes indexed in the database server component 120. Each message in the repository may be named and stored using the methodology identified below.

The application server component 122 implements all information processing logic and primarily manages the insertion, update, deletion, and retrieval of data in the database. The web server, TCAs, and other system components communicate only to the database component 120 via the application server component 122, preserving the integrity of the information. The application server component 122 handles all database replication, dynamically synchronizing information with databases residing in other the application server components of other intelligent servers nodes via the HTTP protocol. The application server component may be JBoss J2EE available from JBoss Group, LLC.

The web server component 124 implements a Java Server Pages (JSP) web application that allows less capable clients to communicate with the intelligent server node 114. In addition, the web server component 124 exposes a web service (e.g., HTTP) based API to the application server 122, thus allowing any computer capable of running a web browser to access the data stored at the intelligent server node 114 via the world wide web. The web server component 124 may be Tomcat available from the Apache Software Foundation.

The messaging server component 126 provides email (SMTP and POP3) functionality, which allows the intelligent server node 114 to send informational messages to any email-enabled system or device. In an alternative embodiment, the application server component 122 may use the messaging server component 126 to replicate database information to other intelligent server nodes 114 in lieu of using the HTTP protocol. The messaging server component may be the Java Apache Mail Enterprise Server (a/k/a Apache JAMES).

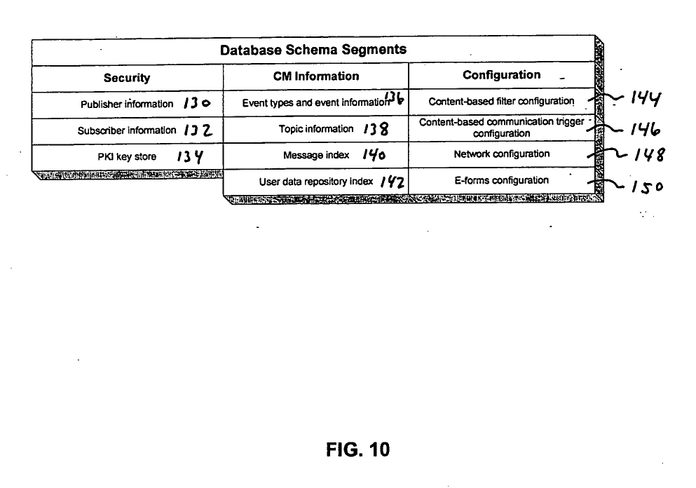

The database server component 128 is preferably composed of several schema segments, each containing data related to a specific system construct. These segments may include, as shown in FIG. 10, publisher information, subscriber information, PKI key store, event types and event information, topic information, message index, user data repository index, content-based filter configuration, content-based communication trigger configuration, network configuration, and E-forms configuration.

The publisher information segment 130 stores information about which entities (users, systems, devices, or programs) can act as information providers to the consequence management system, along with their associated system credentials and user-defined attributes (as defined below). Each publisher would be required to maintain a PKI certificate in the PKI key store 134 to be used for authentication purposes to prevent un-authorized publication of information into the communication management system.

The subscriber information segment 132 stores information about which entities (users, systems, devices, or programs) can act as recipients or consumers of information published to the consequence management system, along with their associated system credentials and user-defined attributes (as defined below). Each subscriber would be required to maintain a PKI certificate in the PKI key store 134 to be used for authentication purposes to prevent unauthorized access to published information.

The PKI key store 134 manages public/private key pairs and associated PKI certificates for use in authentication of publishers and subscribers, or verification of authenticity or data integrity of published information. The key store 134 holds two different types of entries: key entries and trusted certificate entries. Key entries hold very sensitive cryptographic key information, stored in a protected format to prevent un-authorized access. Typically, key entries are secret or private keys accompanied by the PKI certificate chain for the corresponding public key. Trusted certificate entries contain a single public key certificate belonging to a publisher or subscriber. The certificates are “trusted” when they indeed belong to the identified publisher or subscriber, as evidenced by the digital signature from a trusted certificate authority (the consequence management system certificate authority). Keys and certificates are automatically created by the system and issued to new publishers and subscribers by the consequence management system certificate authority when the users complete a one-time system enrollment process.

The event type and event information segment 136 holds categorical information, meta-data, and system and user-defined attributes about various types of consequence management events. Event type and event attributes can function as criteria for content-based filters and communication triggers. For example, users can define filters such as “send me all information related to chemical attack event types that occur in the state of Maryland until the year 2004.” Subsequently, event information is selectively replicated between databases residing on intelligent server nodes based on the content-based filters and communication triggers established throughout the consequence management system. As filters and triggers are created by users that reference certain event attributes, new event information is selectively replicated throughout the consequence management system based on the filters and triggers.

The topic information segment 138 holds information related to topics and their system and user-defined attributes. Topics and their associated attributes function as criteria for content-based filters and communication triggers. For example, users can define filters such as “send me all information related to topics marked with the attribute “is terrorist organization,” or all information within the topic “FBI.” Subsequently, topic information is selectively replicated between databases residing on intelligent server nodes based on the content-based filters and communication triggers established throughout the consequence management system. As filters and triggers are created by users that reference certain topics and attributes, new information is selectively replicated throughout the consequence management system based on the filters and triggers.

The message index segment 140 stores all system and user-defined message attributes, and constitutes an index into messages located in the message store, which is physically part of the file system described below. Messages, their related events and topics, and their attributes function as criteria for content-based filters and communication triggers. For example, users can define filters such as “send me all messages related to the FBI topic marked with the attribute “is warning” that have not expired yet.” Subsequently, messages from the message store are selectively replicated between databases residing on intelligent server nodes based on the content-based filters and communication triggers established throughout the consequence management system. As filters and triggers are created by users that reference certain message attributes, new messages are selectively replicated throughout the consequence management system based on the filters and triggers.

The user data repository index segment 142 stores all system and user-define attributes, and constitutes an index of objects stored in the user-configurable data repository, part of the file system described below. The events, topics, messages, and attributes associated with the files in the user configurable data repository function as criteria for content-based filters and communication triggers. For example, users can define filters such as “send me all files published by any user in the EPA that has been made public that has been marked with a tag ‘contains harmful chemical agents’.” Subsequently, objects from the user configurable data repository are selectively replicated between databases residing on intelligent server nodes based on the content-based filters and communication triggers established throughout the consequence management system. As filters and triggers are created by users that reference certain object attributes, new objects are selectively replicated throughout the consequence management system based on the filters and triggers.

The content-based filter configuration segment 144 contains configuration information for all content-based filters that have been established by users. They constitute the information that defines “queries” that have been formulated by users, such as “send me all files published by any user in the EPA that have been made public that have been marked with a tag ‘contains harmful chemical agents’.” Once a content-based filter has been configured by a user and stored in the database, it is selectively replicated between databases residing on other intelligent server nodes to allow those nodes to intelligently send and retrieve the information.

The content-based trigger configuration segment 146 contains configuration information for all content-based triggers that have been established by users and programmers. They constitute the information that defines the criteria by which communication triggers decide to execute. Once a content-based trigger has been configured by a user or programmer and stored in the database, it is selectively replicated between databases residing on other intelligent server nodes to allow those nodes to intelligently trigger communications whenever information is published or received.

The network configuration segment 148 contains information about the location and addresses of intelligent server nodes 114 on the consequence management system 100, contains quality of service statistics regarding performance of communication and data replication functions, and other lower-level communication related configuration information.

The file system is used to manage the message store and the user-configurable data repository. Information is stored in both the message store and data repository as files. Each file is assigned a UUID. All files are indexed in the database according to the UUIDs and attributes assigned to them. They are located in the file system using a specialized file-naming convention also based on the UUID.

As shown in FIG. 9, the intelligent server node 114 interfaces with a file system 128 and an SQL relational database 152. The file system 128 is used to manage the message store and user-configurable data repository. The message store houses all message objects, each one stored in its own file. Messages are preferably stored in the Multipurpose Internet Mail Extensions (MIME) standard in widespread use on the internet by web, email, and news servers. MIME messages are broken into parts, with each part containing its own unique information. The system uses separate parts to store system attributes, user attributes, and topic associations. User information such as file attachments and message bodies are also stored in separate parts of the message.

The information and attributes of each message are indexed in the message index segment 140 of the database. When the system needs to retrieve a message, it can quickly look up the message UUID in the message index and then retrieve the message from the file system utilizing the UUID once it is known.

The user-configurable data repository houses all user objects, each one stored in its own file. Therefore, anything that can be stored in a computer file can be stored in the user's data repository. The information and attributes of each object are indexed in the user-configurable data repository index segment 142 of the database. When the system needs to retrieve an object from the repository, it can quickly lookup the object's UUID in the database index and then retrieve the object from the file system utilizing the UUID once it is known.

The consequence management system will likely be required to store very large numbers of files. To balance the load on the file system, each file is assigned a UUID and uses the UUID as its file name. The directory path to the file is also based on the UUID and may be determined by a specialized naming convention. A useful property of UUIDs is that they are known to be uniformly random. A four-level deep file system directory structure is dynamically created based on the UUIDs themselves when the files are saved to the file system. Directories are created for each pair of hex digits, starting from the left until four directories are created. For example, consider the UUID a6e2906c4cdd49ef5f5f3faf03153b50. The first four pairs of hex digits are “a6”, “e2”, “90” and “6c” respectively. Therefore, this file's fully specified name in the file system may be “a6/e2/90/6c/a6e2906c4cdd49ef5f5f3faf03153b50.” A pair of hex digits specifies up to 256 unique combinations. Therefore, each directory would have a maximum of 256 subdirectories each. This results in a very well balanced directory structure, ensuring quick file retrievals. Four pairs of hex digits specify up to 256⁴, or 4,294,967,296, over four billion directories. This should far exceed the actual number of files ever stored on a single system at any one time. Any and all files starting with the same four pairs of hex digits would preferably be stored in the same directory.

For clarity, the drawing figures illustrate the general configuration of a preferred embodiment of the system and method. Descriptions and details of well-known features and alternative embodiments of the invention are omitted to avoid unnecessarily obscuring the invention and because people of ordinary skill in the art will appreciate and understand the invention is capable of and teaches various alternative embodiments. The drawings are provided for illustrative purposes only and should not be used to unduly limit the scope of the invention.

The invention provides a system and method to enable military and civil organizations to rapidly execute consequence management functions required after a significant military or civil disaster, such as a terrorist attack or an attack by a weapon of mass destruction resulting in massive casualties, property damage, or disruption of social infrastructure. The method may be used for many other functions including: (i) next generation, secure, spam-less email; (ii) establishing a symantec-based world-wide-web, where the web is indexed and searchable based on symantec content, as opposed to syntactical content; and
(iii) establishing corporate knowledge bases and automated file-sharing environments. Although the invention has been described with reference to a specific prescription dispensing embodiment, as will be understood by those skilled in the art, other embodiments and variations may be made without departing from the spirit or scope of the invention.

1. A method to selectively disseminate information in a distributed computer system having a plurality of originating and target nodes, the method comprising the steps of:
(a) defining a set of publishers authorized to provide information to the system and associating each publisher with an originating node of the system;
(b) defining a set of subscribers authorized to receive information from the system and associating each subscriber with a target node of the system;
(c) publishing a first informational message, wherein the first informational message is defined by a set of attributes related to the content of the informational message;
(d) allowing each subscriber to establish a set of content filters to identify the attributes of informational messages of interest to each subscriber;
(e) screening the first published informational message to determine the subscribers that should receive the informational message based on the subscriber's content filters;
(f) providing a description of the first informational message to the target nodes associated with the subscribers determined to receive the information;
(g) reviewing the description to determine if the target node already contains the first informational message;
(h) notifying the originating node as to whether the target node already contains the first informational message; and
(i) transferring the first published informational message from the originating node associated with the publisher to the target nodes associated with those subscribers requiring the first informational message.

2. The method of claim 1 further comprising the steps of:
(j) allowing each subscriber to establish automatic content-based communication triggers;
(k) screening the first informational message received by a subscriber to determine if the content of the message or its attributes meet an established communication trigger, and
(l) publishing a second informational message in the event the trigger is met.

3. The method of claim 1 further comprising the step of retrieving a third informational message by the subscriber related to the first informational message in the event a trigger is met.

4. The method of claim 3 wherein the step of publishing a second informational message comprises the step of publishing the third informational message by the subscriber.

5. The method of claim 1 wherein the step of screening is performed by the originating node associated with the publisher.

6. The method of claim 1 further comprising the steps of:
(a) associating a data repository with a published informational message, wherein the data repository contains additional information related to the content of the informational message; and
(b) allowing a subscriber receiving the published informational message to access the data repository associated with the received informational message.

7. The method of claim 1 further comprising the steps of:
(a) associating a data repository with a published informational message, wherein the data repository contains additional information related to the content of the informational message;
(b) publishing attributes identifying the information contained in the data repository;
(c) screening the published attributes to determine the subscribers that should receive the additional information contained in the data repository based on the subscriber's content filters; and
(d) providing the additional information to the target nodes associated with those subscribers requiring the additional information.

8. The method of claim 1 further comprising the step of enrolling a publisher as a verified provider of information to the system.

9. The method of claim 1 further comprising the step of enrolling a subscriber as a verified recipient of information from the system.

10. The method of claim 1 wherein the publishers are selected from the group comprising users, external systems, external programs, and hardware devices.

11. The method of claim 1 wherein the step of publishing a first informational message comprises the steps of:
(a) associating credentials with each publisher that define the types of informational messages each publisher is allowed to publish to the system; and
(b) evaluating the informational message prior to publication to ensure that the publisher has the appropriate system credentials to publish the informational message.

12. The method of claim 1 wherein the step of transferring the first published informational message comprises the step of verifying that the subscriber is authorized to received the published informational message.

13. The method of claim 1 wherein the step of publishing a first informational message comprises the steps of defining a plurality of event types and upon the occurrence of a specific event of a defined event type, publishing an informational message containing information relating to the occurrence of the specific event.

14. The method of claim 1 wherein each subscriber has an associated public encryption key and wherein each transferred informational message is encrypted using the subscriber's public encryption key.

15. A computer program product on a computer readable medium for use in a distributed computer system having a plurality of originating and target nodes, the computer program product comprising:
(a) instructions for defining a set of publishers authorized to provide information to the system and associating each publisher with an originating node of the system;
(b) instructions for defining a set of subscribers authorized to receive information from the system and associating each subscriber with a target node of the system;
(c) instructions for publishing a first informational message, wherein the first informational message is defined by a set of attributes related to the content of the informational message;
(d) instructions for allowing each subscriber to establish a set of content filters to identify the attributes of informational messages of interest to each subscriber;
(e) instructions for screening the first published informational message to determine the subscribers that should receive the informational message based on the subscriber's content filters;
(f) instructions for providing a description of the first informational message to the target nodes associated with the subscribers determined to receive the information;
(g) instructions for reviewing the description to determine if the target node already contains the first informational message;
(h) instructions for notifying the originating node as to whether the target node already contains the first informational message; and
(i) instructions for transferring the first published informational message from the originating node associated with the publisher to the target nodes associated with those subscribers requiring the first informational message.
